(19) United States
(12) Patent Application Publication
(10) Pub. No.: US 2014/0082180 A1
(43) Pub. Date: Mar. 20, 2014

(54) INFORMATION PROCESSOR APPARATUS, INFORMATION PROCESSING METHOD, AND RECORDING MEDIUM

(71) Applicant: FUJITSU LIMITED, Kawasaki-shi (JP)

(72) Inventors: Ryoichi MUTOH, Kawasaki (JP); Naoki Oguchi, Kawasaki (JP)

(73) Assignee: FUJITSU LIMITED, Kawasaki-shi (JP)

(21) Appl. No.: 13/904,730

(22) Filed: May 29, 2013

(30) Foreign Application Priority Data
Sep. 18, 2012 (JP) 2012-204905

(51) Int. Cl. H04L 12/26

(52) U.S. Cl. CPC H04L 12/2676
USPC 709/224

(57) ABSTRACT

An information processor apparatus includes a memory which stores a program, and a processor, based on the program, configured to, detect a packet that is transmitted from a management device to a second node that is included in a second network, and that triggers a request packet transmitted from the second node to a first node that is included in a first network, by monitoring communication from the management device that manages the first node and the second node that obtains data from the first node through a third network, and execute a proxy request by transmitting the request packet to the first node when the packet is detected and a connection is made with the first network.

### CROSS-REFERENCE TO RELATED APPLICATION

This application is based upon and claims the benefit of priority from the prior Japanese Patent Application No. 2012-204905 filed on Sep. 18, 2012, the entire contents of which are incorporated herein by reference.

### FIELD

The embodiments discussed herein relate to an information processor apparatus, an information processing method, and a recording medium.

### BACKGROUND

Transmission control protocol (TCP) is a protocol of connection types. To guarantee data reachability in TCP, a receiving node transmits a reception response (ACK) to a transmitting node upon receiving a certain number of data packets. The transmitting node waits until the ACK is received to send the next certain amount of data packets. With the use of ACK in this way in communication using TCP, an amount of time is taken from the time the receiving node requests transmission until the receiving node receives all the data packets.

One method of reducing the time desired for transmission when conducting transmission through a WAN involves the use a WAN acceleration device. For example, a WAN acceleration device is located at a border between a WAN and an internal network such as a LAN, and operates as a proxy for devices inside the internal network. The WAN acceleration device does not operate as a proxy at the TCP/IP model application layer level, but operates as a proxy for conducting relays and transfers at the lower transport layer or internet layer levels.

FIG. 1 illustrates an example of a WAN acceleration device operation. In FIG. 1, a transmitting node P2 and a receiving node P3 belong to different networks that are connected to each other through a WAN. A WAN acceleration device P1A is a proxy for the network to which the transmitting node P2 belongs. A WAN acceleration device P1B is a proxy for the network to which the transmitting node P3 belongs. According to the WAN acceleration device P1A, the internal network is the one to which the transmitting node P2 belongs, and the external networks are the ones to which the WAN and the receiving node P3 belong. According to a WAN acceleration device P1B, the internal network is the one to which the receiving node P3 belongs, and the external networks are the ones to which the WAN and the receiving node P3 belong.

The WAN acceleration device P1A receives a data packet from the transmitting node P2 (OP111) and then transfers the data packet to the receiving node P3 (OP112). Further, the WAN acceleration device P1A artificially creates an ACK packet (pseudo ACK packet) and transmits the pseudo ACK packet to the transmitting node P2 (OP112). The transmitting node P2 transmits the next data packet upon receiving the pseudo ACK packet (OP115). Similarly, the WAN acceleration device P1A transfers the data packet to the receiving node P3 and transmits a pseudo ACK to the transmitting node P2.

Conversely, the WAN acceleration device P1B that is the proxy for the receiving node P3 receives the data packet through the WAN and transmits the data packet to the receiving node P3 (OP113). Data packets from the transmitting side WAN acceleration device P1A arrive in sequence at the WAN acceleration device P1B (OP116), and the data packets are buffered by the WAN acceleration device P1B. When an ACK is received from the receiving node P3 (OP114), the WAN acceleration device P1B reads the next data packet from the buffer and transmits the data packet to the receiving node P3 (OP117). In communication using a normal TCP, the time from the receiving node P3 transmitting the ACK until the next data packet is received takes at least one round trip time (RTT). In comparison, the time may be shortened due to the WAN acceleration device P1A transmitting a pseudo packet to the transmitting node P2.

Communication between the WAN acceleration devices P1A and P1B may be processed using, for example, protocols unique to the vendors of the devices. Further, SYN packets or FIN packets transmitted at the connection or disconnection of the TCP connection are relay-transferred by the WAN acceleration device P1A without a response being made with a pseudo ACK packet.

Normally a TCP proxy re-writes the transmission source IP address, the transmission source TCP port number, the destination IP address, and the destination TCP port number of the reception packet when transferring the packet. Conversely, a transparent proxy acts as the connection partner and conducts a proxy response without re-writing the transmission source IP address, the transmission source TCP port number, the destination IP address, and the destination TCP port number of the reception packet. As a result, a transparent proxy is not recognized as an existing proxy in the node.

The trigger for the transmitting node to transmit a data packet is the reception of a request from the receiving node in normal communication using TCP, although this has been omitted in the example illustrated in FIG. 1 in order to explain the operation of the WAN acceleration devices. For example, a request packet for requesting data is transmitted from the receiving node P3 to the transmitting node P2 before OP111 in the example illustrated in FIG. 1. After the transmission process for data requested through one request packet in OP111 to OP118 in FIG. 1, a request packet for requesting the next data is transmitted by the receiving node P3 after OP118, and the processing from OP111 to OP118 is repeated. Specifically, transmission of the next data does not start until the transmitting node P2 receives a request packet from the receiving node P3.

Accordingly, in order to reduce the time of the communication, a method is described in Japanese Patent Laid-open No. 2011-039899 in which a prefetch proxy server carries out a prefetch request preceding a request from a PC. In this method, when Web information transmitted to a Web browser is transferred from a Web server, the prefetch proxy server transmits, to the Web server, prefetch request data for requesting prefetch target Web information that is predicted for the next request by the Web browser from the Web information. Further, the prefetch proxy server obtains the Web information corresponding to the prefetch request data and transfers the prefetched Web information to an information storage server. The information storage server stores the prefetched Web information transferred from the prefetch proxy server and transmits to the Web browser the Web information corresponding to the requested data requested by the Web browser.

### SUMMARY

According to an aspect of the invention, an information processor apparatus includes a memory which stores a program, and a processor, based on the program, configured to, detect a packet that is transmitted from a management device to a second node that is included in a second network, and that triggers a request packet transmitted from the second node to a first node that is included in a first network, by monitoring communication from the management device that manages the first node and the second node that obtains data from the first node through a third network, and execute a proxy request by transmitting the request packet to the first node when the packet is detected and a connection is made with the first network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a WAN acceleration device operation;

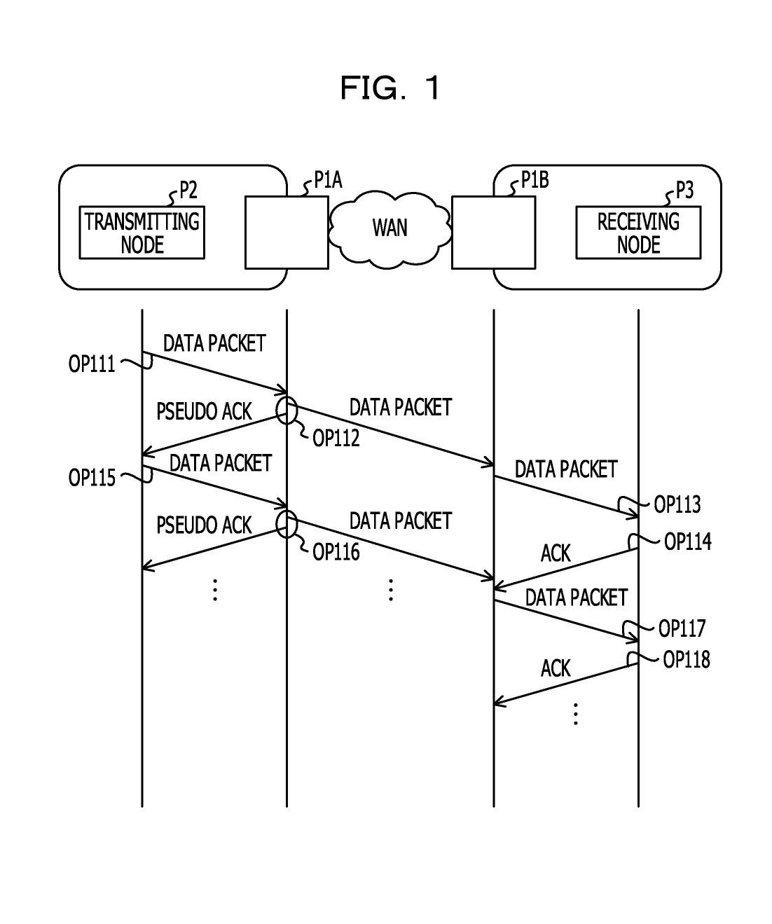

FIG. 2 illustrates an example of a configuration of a system using Hadoop;

FIG. 3 illustrates an example of distributed processing with Hadoop;

FIG. 4 illustrates an example of a sequence of transmissions and receptions of intermediate data in Hadoop;

FIG. 5 illustrates an example of a system configuration when Hadoop is run in different data centers connected through a WAN;

FIG. 6 illustrates an example of a sequence of transmissions and receptions of intermediate data in the system illustrated in FIG. 5;

FIG. 7 describes a hardware configuration of a WAN acceleration device;

FIG. 8 is an example of a functional block of a WAN acceleration device according to a first embodiment;

FIG. 9 illustrates an example of an intermediate data session management table;

FIG. 10 is an example of a flow chart of processing related to a proxy request or a proxy response of a WAN acceleration device;

FIG. 11 illustrates an example of a sequence chart of processing related to a proxy request or a proxy response in the system illustrated in FIG. 5;

FIG. 12 illustrates an example of a TCP session association table held by a WAN acceleration device on a Reduce task node side;

FIG. 13 illustrates an example of a sequence of a TCP session establishment before the transmission and reception of intermediate data according to a second embodiment;

FIG. 14 illustrates an example of a system of a first modified example;

FIG. 15 illustrates an example of a system of a second modified example.

### DESCRIPTION OF EMBODIMENTS

According to studies on the WAN acceleration device by the present inventor, the data to be requested next may not be read from the transmitting node without waiting for the response from the receiving node even when the data from the transmitting node or the receiving node is monitored. For example, there is a case in which the transmission and reception of data is conducted between slave nodes in a distributed cluster in which a plurality of slave nodes exist with respect to one master node.

According to the belowmentioned embodiment, the time from the receiving node request transmission until the completion of the data reception may be shortened in a system for conducting communication proxy requests and proxy responses between a receiving node and a transmitting node.

Embodiments described hereinbelow will be explained with reference to the drawings. Configurations of the embodiments are merely examples and are not limited to such configurations.

### First Embodiment

A system that uses Hadoop will be described in a first embodiment as an example of a distributed processing framework.

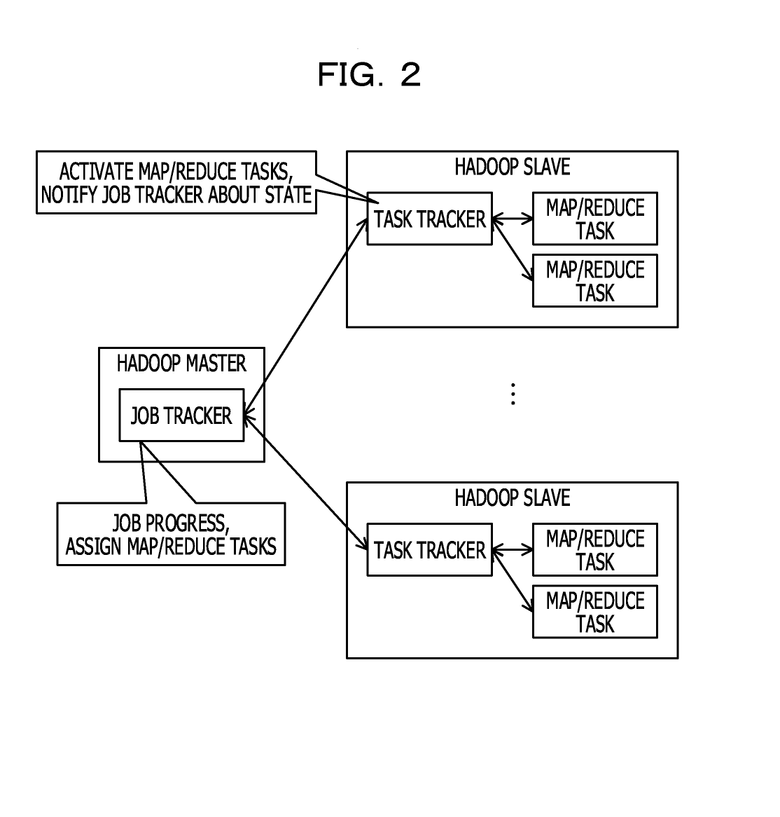

FIG. 2 illustrates an example of a configuration of a system using Hadoop. Hadoop is a framework for processing big data in parallel at high speed. Hadoop is a master/slave type framework having one master (indicated as a “Hadoop master” in the drawing) and a plurality of slaves (indicated as a “Hadoop slave” in the drawing) in a system. The master operates as a Job Tracker. A Job Tracker manages job progression status and assigns processing to Map tasks and Reduce tasks. Each slave operates as a Task Tracker. A Task Tracker activates a Map task group and a Reduce task group in each slave and manages the progression status of each task. In the first embodiment, a job is a group of a plurality of tasks. A Task Tracker that executes a Map task is referred to below as a Map task node. A Task Tracker that executes a Reduce task is referred to as a Reduce task node.

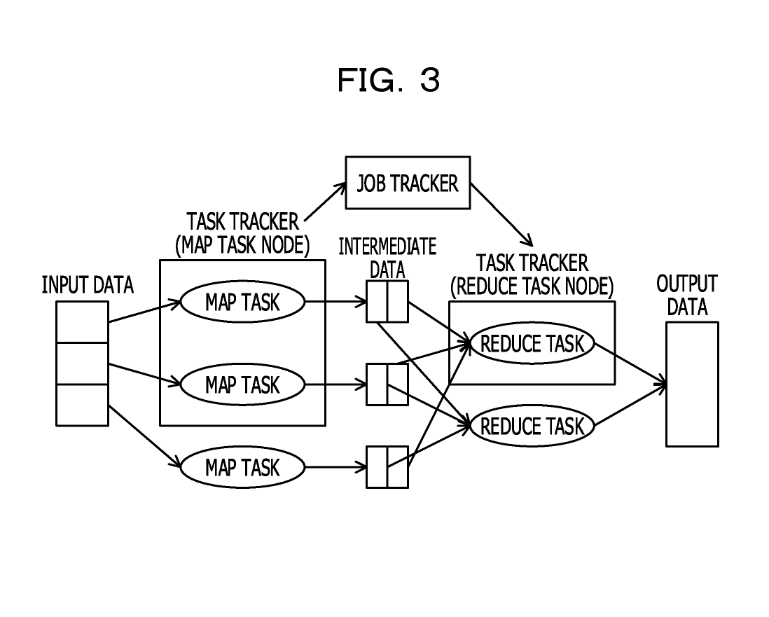

FIG. 3 illustrates an example of distributed processing with Hadoop. Input data is divided so that intermediate data is created in each Map task in Hadoop. The intermediate data is tallied by Reduce tasks and the results outputted by the Reduce tasks become output data. Which Task Tracker executes a Map task or a Reduce task is dynamically determined by the Job Tracker for each job.

The Job Tracker and the Task Tracker regularly exchange messages called heartbeats to notify each other about the progression statuses of tasks and jobs. The Task Tracker confirms the existence of the Job Tracker and notifies the Job Tracker about the statuses of the Map tasks or the Reduce tasks using heartbeats. A heartbeat response is sent from the Job Tracker back to the Task Tracker along with any commands as occasion calls.

When a Map task process is completed, the Map task notifies the Task Tracker in the same node about the completion. The Task Tracker notifies the Job Tracker about the Map task completion, and the Job Tracker notifies the Task Tracker assigned the execution of the Reduce task about the completion of the Map task. The Reduce task receives the Map task processing result, that is, receives the intermediate data from the Task Tracker of the Map task. The transmission and reception of the intermediate data is conducted using HTTP.

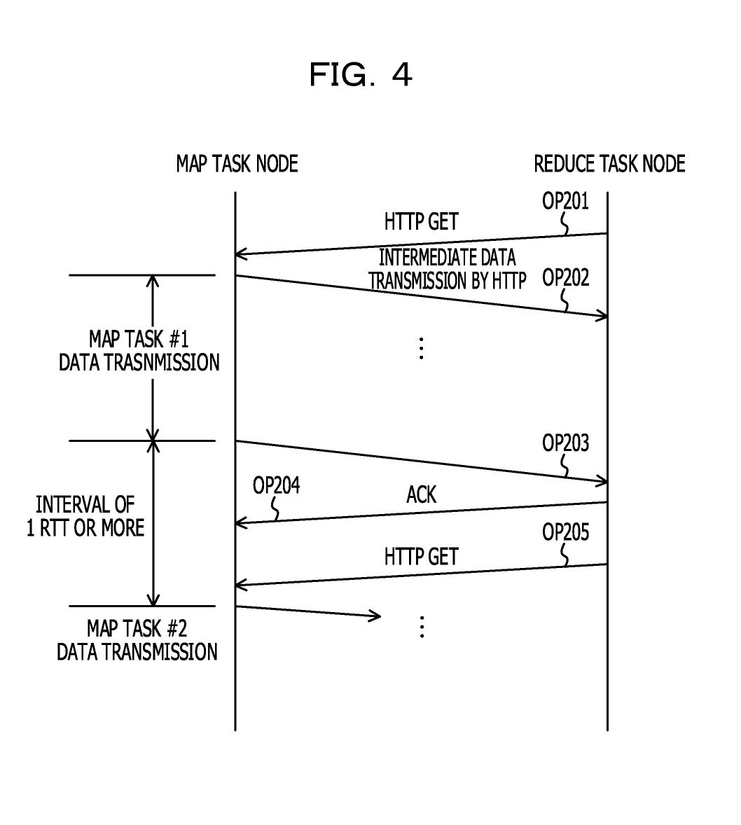

FIG. 4 illustrates an example of a sequence of transmissions and receptions of intermediate data in Hadoop. The transmission and reception of intermediate data is started when an HTTP GET request is transmitted from the reduce task node (OP201). The Map task node transmits the intermediate data as a response to the HTTP GET request (OP202).

A Reduce task is only able to request intermediate data in order when a plurality of Map tasks is executed in the same Map task node. When a Map task #1 and a Map task #2 are executed in the same Map task node, the Reduce task receives the last data packet of intermediate data on the Map task #1 (OP203) and then transmits a reception confirmation response (ACK) with respect to the last data packet. The Reduce task then transmits a HTTP GET request for requesting the intermediate data of the Map task #2 (OP205). Therefore, an interval of at least one RTT portion is created from when the Map task #1 intermediate data transmission is completed (OP203) until the transmission of the intermediate data of the next Map #2 task is started (OP205).

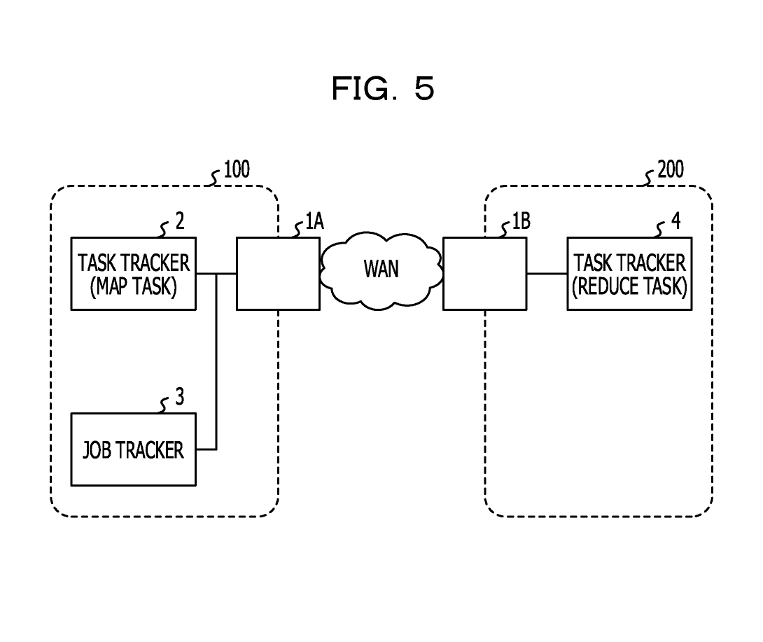

FIG. 5 illustrates an example of a system configuration when Hadoop is run in different data centers connected through a WAN. In FIG. 5, Hadoop is run between a data center 100 and a data center 200. The data center 100 and the data center 200 are both built by LANs and the like. A WAN exists between the data center 100 and the data center 200.

The data center 100 includes a Task Tracker 2, a Job Tracker 3, and a WAN acceleration device 1A. The Task Tracker 2 in FIG. 5 is a Map task node. The network of the data center 100 is an internal network from the point of view of the WAN acceleration device 1A. The WAN and the network in the data center 200 are external networks from the point of view of the WAN acceleration device 1A.

The data center 200 includes a Task Tracker 4 and a WAN acceleration device 1B. The Task Tracker 4 in FIG. 5 is a Reduce task node. The network of the data center 200 is an internal network from the point of view of the WAN acceleration device 1B. The WAN and the network in the data center 100 are external networks from the point of view of the WAN acceleration device 1B. WAN communication between the data centers is carried out by the WAN acceleration devices 1A and 1B.

As illustrated in the example in FIG. 5, when Hadoop is run with different data centers, the interval of the previous RTT portion increases since the time taken for WAN communication becomes longer and thus the execution time of the entire job is greatly affected.

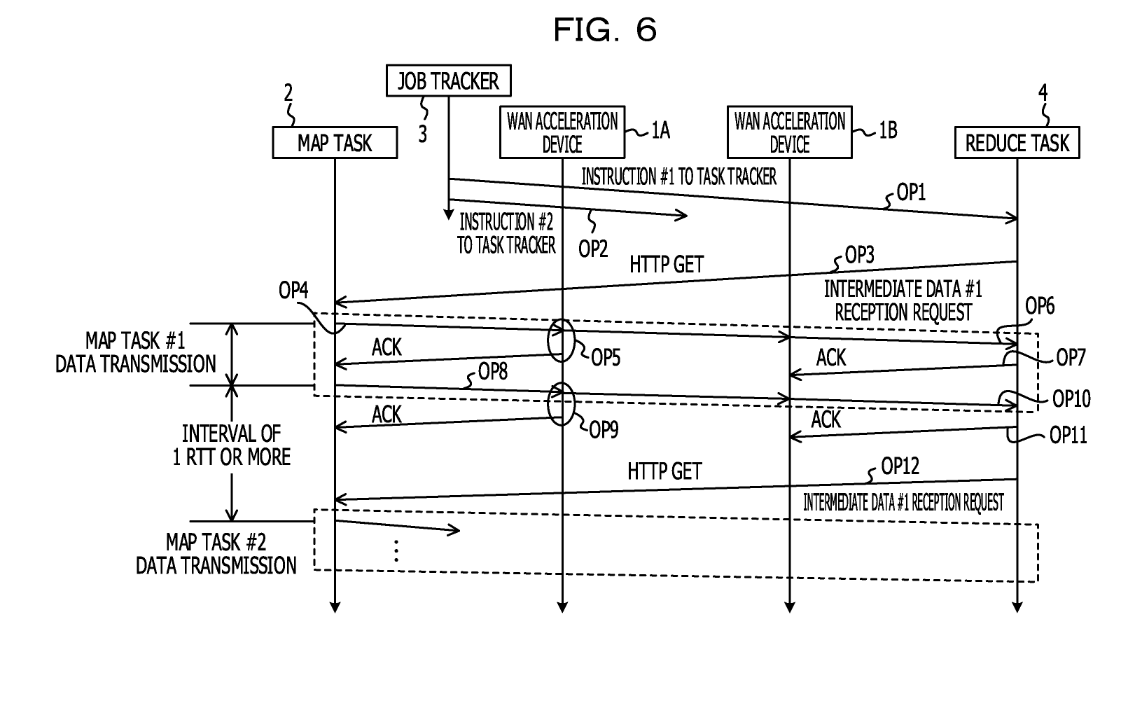

FIG. 6 illustrates an example of a sequence of transmissions and receptions of intermediary data in the system illustrated in FIG. 5. The Job Tracker 3 conducts Reduce task assignation upon receiving Map task completions from all the Map tasks. The example illustrated in FIG. 6 is an example in which intermediate data is transmitted and received when the Job Tracker 3 assigns the Map task #1 and #2 intermediate data created by the Map task node 2 to the Reduce task node 4. The WAN acceleration devices 1A and 1B are transparent proxies.

In OP1, an “org.apache.hadoop.mapred.TaskCompletionEvent” message which is an indication that the Map task #1 intermediate data has been obtained is transmitted from the Job Tracker 3 to the Reduce task node 4. In OP2, the “org.apache.hadoop.mapred.TaskCompletionEvent” message which is an indication that the Map task #2 intermediate data has been obtained is transmitted from the Job Tracker 3 to the Reduce task node 4.

In OP3, an HTTP GET request is transmitted to the Map task node 2 as a reception request for the Map task #1 intermediate data (referred to as “intermediate data #1” below) from the Reduce task node 4 that received the instruction from the Job Tracker 3. Since Reduce task nodes are only able to receive intermediate data from the same Map task node in order, the reception request for the intermediate data #1 is transmitted first in OP3.

In OP4, the data packets of the intermediate data #1 are transmitted by the Map task node 2 that received the intermediate data #1 reception request from the Reduce task node 4. In OP5, the WAN acceleration device 1A transfers to the Reduce task node 4 the data packets of the intermediate data #1 transmitted by the Map task node 2 and also carries out a proxy response by transmitting a pseudo ACK to the Map task node 2.

In OP6, the WAN acceleration device 1B receives the data packets of the intermediate data #1 via the WAN and transfers the data packets to the Reduce task node 4. In OP7, the Reduce task node 4 that received the data packets of the intermediate data #1 transmits an ACK. The ACK is terminated by the WAN acceleration device 1B.

The same processing as in OP4 to OP7 is repeated (OP8 to OP11) until the reception of all the data packets of the intermediate data #1 is completed.

In OP12, the Reduce task node 4 transmits an HTTP GET request as the next reception request for the intermediate data #2 since the reception response (ACK) with respect to the last data packet of the intermediate data #1 has been transmitted (OP11). Thereafter, operations similar to the transmission and reception operations of the intermediate data #1 are carried out.

When running Hadoop on different data centers that communicate over a WAN, the distance between the Map task node 2 and the Reduce task node 4 is longer than the distance thereof within the same data center, and the RTT is increased by that amount. As a result, with the introduction of a WAN acceleration device, the time desired for transmitting and receiving one instance of intermediate data can be reduced by the WAN acceleration device conducting a proxy response using a pseudo ACK. However, it takes one RTT portion of time from the time that the Reduce task node 4 first transmits the intermediate data reception request until the intermediate data is received (e.g., OP3 to OP6 in FIG. 6), and the increased RTT portion is added to the time taken in comparison to the case of running Hadoop within the same data center. Furthermore, an interval of more than one RTT is still created from the time that the transmission of one instance of intermediate data is completed until the time the next transmission of intermediate data is started in a Map task node (e.g., from OP8 to OP13 in FIG. 6).

In the first embodiment, the WAN acceleration device 1A monitors communication from the internal network to the external network and conducts snooping of the instructions to obtain the intermediate data transmitted by the Job Tracker 3. The WAN acceleration device 1A uses the information obtained from the snooping and conducts a proxy request with respect to the Map task node 2 without waiting for an intermediate data request packet from the Reduce task node 4. Hereafter, the WAN acceleration devices will be indicated as a “WAN acceleration device 1” when there is no distinction between the WAN acceleration devices 1A and 1B.

It is assumed in the first embodiment that the IP address and TCP port number of the Job Tracker 3 are set by a user in the WAN acceleration device 1. The IP addresses and TCP port numbers of the Job Trackers are written as “mapred.job.tracker” in configuration files in Hadoop.

Additionally, it is assumed in the first embodiment that the TCP port numbers used by the Map Task nodes are set in the WAN acceleration device 1. The TCP port numbers used by the Task Trackers that have become Map task nodes are written as “mapred.task.tracker.http.address” in configuration files in Hadoop. It is assumed in the first embodiment that a TCP session between the Map task node 2 and the Reduce task node 4 is established.

(WAN acceleration device configuration)

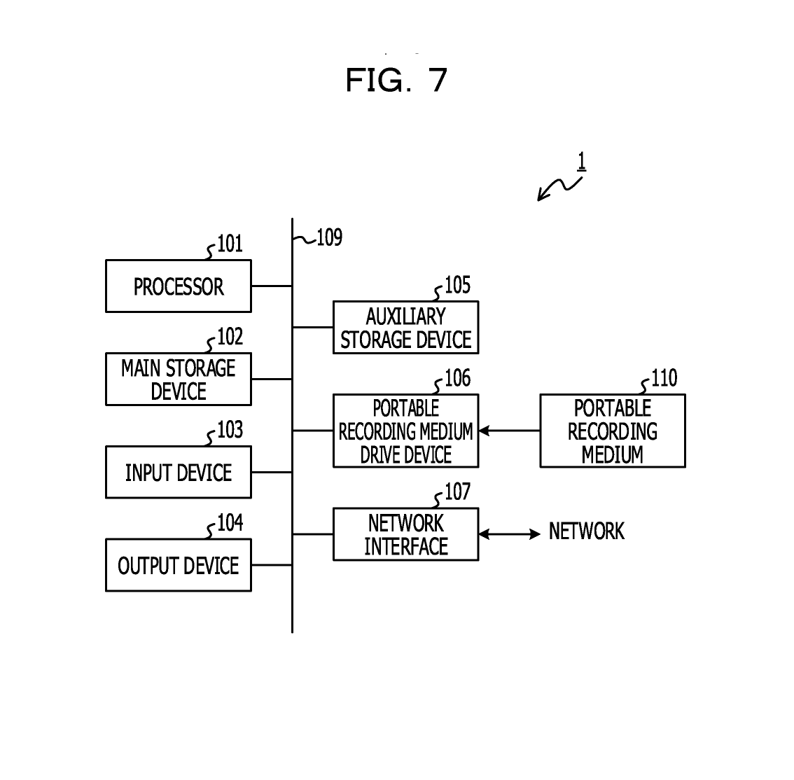

FIG. 7 describes a hardware configuration of a WAN acceleration device 1. The WAN acceleration device 1 may be, for example, a dedicated computer or a general-use computer operating as a server. In the first embodiment, the WAN acceleration device 1 is a computer that operates as a TCP proxy.

The WAN acceleration device 1 is equipped with a processor 101, a main storage device 102, an input device 103, an output device 104, an auxiliary storage device 105, a portable recording medium drive device 106, and a network interface 107. The above components are connected to each other with a bus 109.

The input device 103 may be, for example, a touch panel or a keyboard and the like. Data input from the input device 103 is output to the processor 101.

The portable recording medium drive device 106 reads programs and various types of data recorded on a portable recording medium 110 and outputs the programs and data to the processor 101. The portable recording medium 110 may be, for example, a recording medium such as an SD card, a mini SD card, a micro SD card, a universal serial bus (USB) flash memory, a compact disc (CD), a digital versatile disc (DVD), or a flash memory card.

The network interface 107 is an interface for conducting the input and output of information to and from a network. The network interface 107 is connectable to a wired network and a wireless network. The network interface 107 may be, for example, a network interface card (NIC) or a wireless local area network (LAN) card. Data and the like received at the network interface 107 is outputted to the processor 101.

The auxiliary storage device 105 stores various programs and data used by the processor 101 when executing programs. The auxiliary storage device 105 may be, for example, a non-volatile memory such as an erasable programmable ROM (EPROM) or a hard disk drive. The auxiliary storage device 105 may hold, for example, an operating system (OS), a proxy process program, or another type of application program.

The main storage device 102 is used as a buffer and provides, for the processor 101, an operating region and a storage region for loading programs stored in the auxiliary storage device 105. The main storage device 102 may be, for example, a semiconductor memory such as a random access memory (RAM).

The processor 101 may be, for example, a central processing unit (CPU). The processor 101 executes various types of processing by loading the OS and various application programs held in the auxiliary storage device 105 or the portable recording medium 110 into the main storage device 102 and executing the OS and the various application programs. The processor 101 is not limited to one and more than one may be provided.

The output device 104 outputs processing results of the processor 101. The output device 104 includes devices such as a printer, a display, and an audio output device such as a speaker.

For example, the processor 101 of the WAN acceleration device 1 loads the proxy processing program stored in the auxiliary storage device 105 into the main storage device 102 to execute the proxy processing program. By executing the proxy processing program, the WAN acceleration device 1 monitors communication between the internal data center and the external data center. The WAN acceleration device 1 also conducts snooping of instructions to obtain intermediate data transmitted by the Job Tracker 3 and conducts proxy requests to the Map task node 2 and proxy responses to the Reduce task node 4 (proxy processing). The hardware configuration of the WAN acceleration device 1 is merely an example and is not limited to the above configuration. The omission, substitution and addition of appropriate constituent elements may be conducted according to an embodiment. A proxy processing program, for example, may be recorded on the portable recording medium 110.

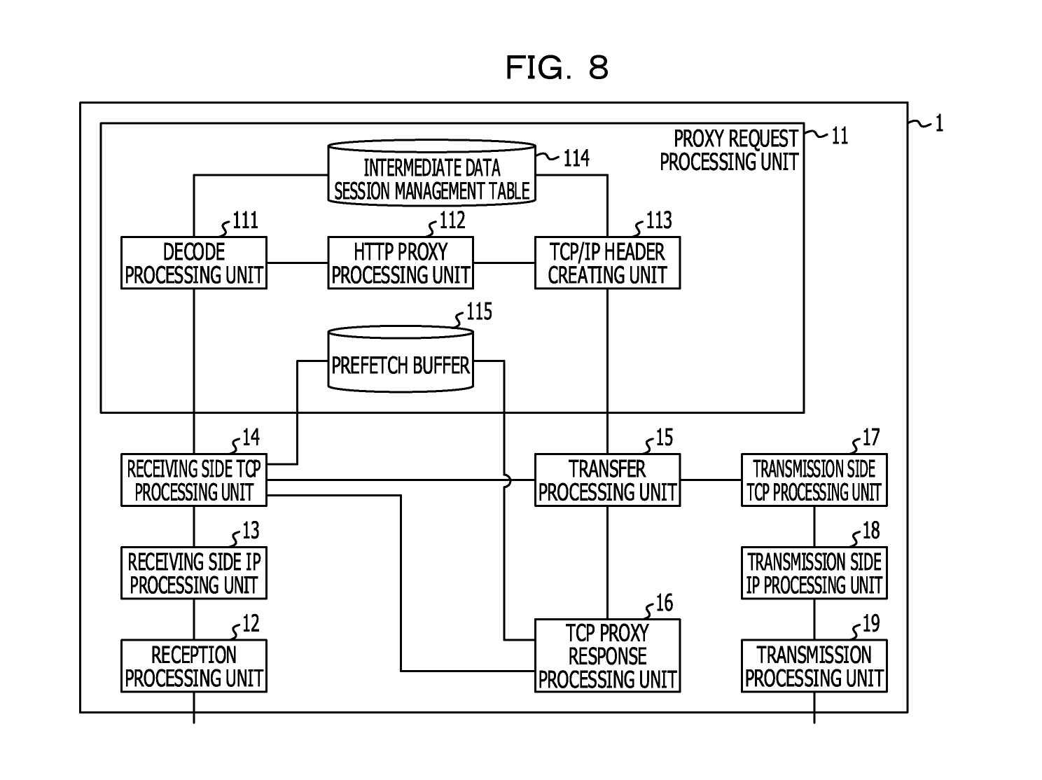

FIG. 8 is an example of a functional block of a WAN acceleration device 1 according to the first embodiment. The WAN acceleration device 1 operates as a proxy request processing unit 11, a reception processing unit 12, a receiving side IP processing unit 13, a receiving side TCP processing unit 14, a transfer processing unit 15, a TCP proxy response processing unit 16, a transmission side TCP processing unit 17, a transmission side IP processing unit 18, and a transmission processing unit 19. The functional blocks of the WAN acceleration device 1 are not limited to being realized by software processing by the processor 101 and may be realized by hardware. For example, a large scale integration (LSI) or a field-programmable gate array (FPGA) may be included in the hardware for realizing the functional blocks of the WAN acceleration device 1. In the first embodiment, the WAN acceleration device 1 operates as a transparent proxy. For convenience, the system configuration described in FIG. 5 is assumed in the following explanation of the functional blocks. The processing shared by the WAN acceleration device 1A on the Map task node 2 side and the WAN acceleration device 1B on the Reduce task node 4 side is separated in the following explanation and will be explained as the processing of the WAN acceleration device 1A on the Map task node 2 side and the processing of the WAN acceleration device 1B on the Reduce task node 4. In Hadoop, the Map task nodes and the Reduce task nodes are determined dynamically by the Job Tracker. As a result, the WAN acceleration device 1 operates as the WAN acceleration device 1A on the Map task node 2 side and the WAN acceleration device 1B on the Reduce task node 4 side.

(Shared processing)

The reception processing unit 12, the receiving side IP processing unit 13, and the receiving side TCP processing unit 14 respectively conduct processing relating to a network interface layer, an internet layer, and a transport layer in a TCP/IP reference model for each reception packet. Specifically, the receiving side IP processing unit 13 conducts processing relating to information obtained from the IP header of a reception packet. The receiving side TCP processing unit 14 conducts processing relating to information obtained from a TCP header and an application header of the reception packet, and outputs the reception packet to the transfer processing unit 15. The receiving side TCP processing unit 14 also detects packets asking for a TCP ACK response and notifies the TCP proxy response processing unit 16. A reception packet that is a packet that asking for an ACK response is detected, for example, by the type of TCP packet (TCP SYN packet, etc.), a sequence number inside the TCP header, or an acknowledgment number and the like.

The TCP proxy response processing unit 16 conducts processing relating to a proxy response. Specifically, upon receiving a notification from the receiving side TCP processing unit 14, the TCP proxy response processing unit 16 creates a pseudo ACK as a client and outputs the pseudo ACK to the transfer processing unit 15.

The transfer processing unit 15 outputs the packets inputted from the receiving side TCP processing unit 14 and the pseudo ACK inputted from the TCP proxy response processing unit 16 and the like to the transmission side TCP processing unit 17.

The transmission side TCP processing unit 17, the transmission side IP processing unit 18, and the transmission processing unit 19 respectively conduct processing relating to the transport layer, the internet layer, and the network interface layer on the transmission packets to be transferred by the transfer processing unit 15.

The proxy request processing unit 11 conducts proxy requests to the Map task node 2. The proxy request processing unit 11 includes a decode processing unit 111, a HTTP proxy processing unit 112, a TCP/IP header creating unit 113, an intermediate data session management table 114, and a prefetch buffer 115. The intermediate data session management table 114 and the prefetch buffer 115 are stored, for example, in a storage region of the main storage device 102.

In Hadoop, completions of Map task executions are collected by the Job Tracker 3. When all the Map tasks are completed, the Job Tracker 3 transmits a “org.apache.hadoop.mapred.TaskCompletionEvent” message for notifying the Reduce task node 4 about the completion of the Map tasks. The IP address, the TCP port number of the Map task node 2 that holds the intermediate data assigned to the transmission destination Reduce task, and the Map task ID are included in the “org.apache.hadoop.mapred.TaskCompletionEvent” message. Upon receiving the “org.apache.hadoop.mapred.TaskCompletionEvent” message, the Reduce task node 4 transmits a HTTP GET request for requesting the intermediate data to the Map task node 2 that has the intermediate data indicated in the “org.apache.hadoop.mapred.TaskCompletionEvent” message.

Therefore, the “org.apache.hadoop.mapred.TaskCompletionEvent” message transmitted from the Job Tracker 3 is detected since the proxy request to the Map task node 2 and the proxy response to the Reduce task node 4 are conducted in the WAN acceleration device 1. The processing by the WAN acceleration device 1 to detect the “org.apache.hadoop.mapred.TaskCompletionEvent” message is described below.

The receiving side TCP processing unit 14 outputs the reception packets to the transfer processing unit 15 and outputs a copy of the reception packets to the proxy request processing unit 11 if the transmission source IP address and the transmission source TCP port number of the reception packets are those of the Job Tracker 3. The IP address and the used TCP port number of the Job Tracker 3 are, for example, previously stored in a storage region of the main storage device 102 by a user setting in the WAN acceleration device 1.

The decode processing unit 111 of the proxy request processing unit 11 decodes the payload portion of the copy of the reception packets which are inputted from the receiving side TCP processing unit 14 and for which the transmission source thereof is the Job Tracker 3, and checks the message included in the reception packets. If the message is the “org.apache.hadoop.mapred.TaskCompletionEvent” message, the decode processing unit 111 extracts the IP address of the Map task node 2, the port number of the Map task node 2, and the Map task ID from the “org.apache.hadoop.mapred.TaskCompletionEvent” message. The decode processing unit 111 further extracts the target IP address of the reception packets included in the “org.apache.hadoop.mapred.TaskCompletionEvent” message as the IP address of the Reduce task node 4. The extraction of information from packets addressed to another device in this way is referred to as snooping. The decode processing unit 111 registers, in the intermediate data session management table 114, the IP address of the Map task node 2 and the IP address of the Reduce task 4 extracted from the reception packets that include the “org.apache.hadoop.mapred.TaskCompletionEvent” message. The decode processing unit 111 discards the reception packets (copy) if the message is not the “org.apache.hadoop.mapred.TaskCompletionEvent” message. The decode processing unit 111 is an example of a “detecting unit.” The “org.apache.hadoop.mapred.TaskCompletionEvent” message is an example of a “packet that triggers a transmission of a request packet.”

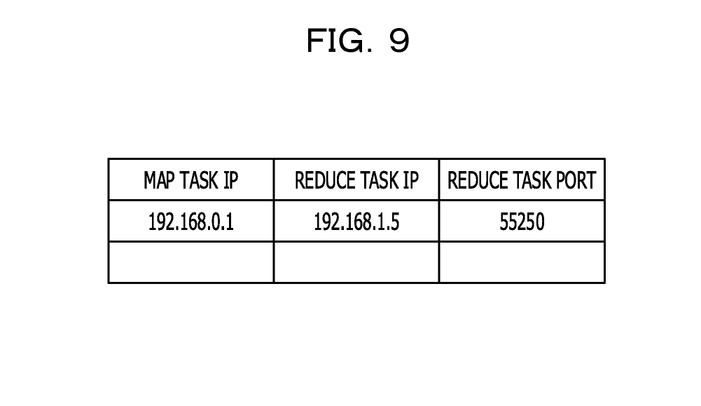

FIG. 9 illustrates an example of the intermediate data session management table 114. The intermediate data session management table 114 holds information about a TCP session established between the Map task node 2 and the Reduce task node 4 and used for transmitting and receiving intermediate data.

An IP address if a Map task node, an IP address of a Reduce task node, and a TCP port number of a Reduce task node are stored in the intermediate data session management table 114. The IP addresses of the Map task node and the Reduce task node are extracted by the decode processing unit 111 from the reception packet that includes the “org.apache.hadoop.mapred.TaskCompletionEvent” message and registered. The port number of the Reduce task node is, for example, extracted from the applicable TCP session information in the TCP session management information (not illustrated) stored in the WAN acceleration device 1, and registered. The TCP session management information is managed, for example, by the transfer processing unit 15 and stored in a storage region in the main storage device 102.

Since it is assumed in the first embodiment that the port number of the Map task node in the TCP session used for transmitting and receiving the intermediate data is unique, the port number of the Map task node is not stored in the intermediate data session management table 114. However, without being limited as such, if the port number of the Map task node in the TCP session used for transmitting and receiving the intermediate data is not unique, the port number of the Map task node is stored in the intermediate data session management table 114.

(WAN acceleration device 1A processing on the Map task node 2 side)

The WAN acceleration device 1 determines its own operations as the WAN acceleration device 1A on the Map task node 2 side based on the IP addresses of the Map task node 2 and the Reduce task node 4 indicated in the “org.apache.hadoop.mapred.TaskCompletionEvent” message. This determination is conducted by, for example, the HTTP proxy processing unit 112. If the Map task node 2 exists in the internal network and the Reduce task node 4 exists in the external network, the WAN acceleration device 1 determines to operate as the WAN acceleration device 1A on the Map task node 2 side.

Returning to FIG. 8, the HTTP proxy processing unit 112 of the WAN acceleration device 1A creates a proxy request packet from the information extracted from the reception packet. The proxy request packet is a HTTP GET request in the first embodiment. The HTTP proxy processing unit 112 creates a URI that becomes the request target of the data via the HTTP GET request by using the Map task ID extracted from the “org.apache.hadoop.mapred.TaskCompletionEvent” message. The HTTP proxy processing unit 112 of the first embodiment is an example of a “proxy request unit.” The HTTP GET request is an example of a “request packet.”

The Map task ID is written as “attempt_<number1>_<number2>_m_<number3>_<number4>” inside the “org.apache.hadoop.mapred.TaskCompletionEvent” message. The Job ID is written as “job_<number1>_<number2>.” “<number1>” indicates the date and time. “<number2>” is a sequence number of the job executed at that date and time. “<number3>” is a sequence number of the Map task indicated by “<number2>”. “<number4>” is a sequence number of the task in the Map task indicated by “<number3>”. The URI of the request target included in the HTTP GET request is created, for example, as written below:
URI=/mapOutput?job=job_<number1>_<number2>&map=attempt_<number1 >_<number2>_m_<number3>_<number4>

The TCP/IP header creating unit 113 in the WAN acceleration device 1A creates a TCP/IP header for the proxy request packet created by the HTTP proxy processing unit 112. The Map task node 2 IP address extracted from the “org.apache.hadoop.mapred.TaskCompletionEvent” message is set in the target IP address. The Map task node 2 TCP port number extracted from the “org.apache.hadoop.mapred.TaskCompletionEvent” message is set in the target port number. The IP address of the Reduce task node that is the target IP address of the reception packet that includes the “org.apache.hadoop.mapred.TaskCompletionEvent” message is set in the transmission source IP address. The TCP port number of the Reduce task node 4 extracted from the intermediate data session management table 114 based on the Map task node 2 IP address and the Reduce task node 4 IP address is set in the transmission source port number. The proxy request packet is then processed by the transfer processing unit 15, the transmission side TCP processing unit 17, the transmission side IP processing unit 18, and the transmission processing unit 19 and is transmitted to the Map task node 2.

The transmission of the proxy request packet is conducted, for example, just after the reception of the “org.apache.hadoop.mapred.TaskCompletionEvent” message from the Job Tracker 3. When a plurality of proxy requests are created for the same Map task, a proxy request packet for the next intermediate data may be transmitted after the completion of the reception of the one instance of intermediate data from the Map task node 2. Specifically, when a plurality of instances of intermediate data is obtained from the same Map task node 2, the transmission processing of the proxy request packets for the plurality of instances of intermediate data may be conducted in parallel or may be conducted each time an intermediate data reception is completed.

The data packet of the intermediate data transmitted from the Map task node 2 in response to the proxy request packet is transferred by the WAN acceleration device 1A on the Map task node 2 side to the external network. In addition to the transmission of the intermediate data packet, the pseudo ACK is created by the TCP proxy response processing unit 16 and the pseudo ACK is transmitted to the Map task node 2.

(WAN acceleration device 1B processing on the Reduce task node 4 side)

The WAN acceleration device 1 determines whether to operate as the WAN acceleration device 1B on the Reduce task node side according to the IP addresses of the Map task node 2 and the Reduce task node 4 indicated in the “org.apache.hadoop.mapred.TaskCompletionEvent” message. When the Map task node 2 exists in the external network and the Reduce task node 4 exists in the internal network, the WAN acceleration device 1 determines to operate as the WAN acceleration device 1B on the Reduce task node 4 side.

The HTTP proxy processing unit 112 of the WAN acceleration device 1B conducts processing for waiting for HTTP response data (intermediate data) when the “org.apache.hadoop.mapred.TaskCompletionEvent” message is received.

The receiving side TCP processing unit 14 of the WAN acceleration device 1B monitors the reception packets and detects a packet of a TCP session registered in the intermediate data session management table 114. The detected packet is an intermediate data packet transmitted from the Map task node 2. Specifically, the reception packet is one in which the target IP address, the target port number, the transmission source IP address and the transmission source port number respectively match the Reduce task node 4 IP address, the Reduce task node 4 TCP port number, the Map task node 2 IP address, and the Map task node 2 port number. The receiving side TCP processing unit 14 stores the detected intermediate data data packet in the prefetch buffer 115.

The receiving side TCP processing unit 14 of the WAN acceleration device 1B monitors the reception packets and detects a HTTP GET request transmitted from the Reduce task node 4 to the Map task node 2. A HTTP GET request is one in which the target IP address, the target port number, the transmission source IP address and the transmission source port number respectively match the Map task node 2 IP address, the Map task node 2 TCP port number, the Reduce task node 4 IP address, and the Reduce task node 4 port number.

When the detected HTTP GET request is from the Reduce task node 4, the TCP proxy response processing unit 16 determines whether to store the intermediate data data packet of the Map task ID included in the HTTP GET request in the prefetch buffer 115. When the intermediate data data packet of the Map task ID is stored in the prefetch buffer 115, the TCP proxy response processing unit 16 extracts the data packet from the prefetch buffer 115 and transmits the data packet to the Reduce task node by proxy (proxy response). When the intermediate data data packet of the Map task ID is not stored in the prefetch buffer 115, the TCP proxy response processing unit 16 holds the detected HTTP GET request. After the intermediate data data packet of the applicable Map task ID is received and the receiving side TCP processing unit 14 stores the data packet in the prefetch buffer 115, the TCP proxy response processing unit 16 reads the data packets in the prefetch buffer 115 in order and transmits the data packets to the Reduce task node 4.

(Operation Example)

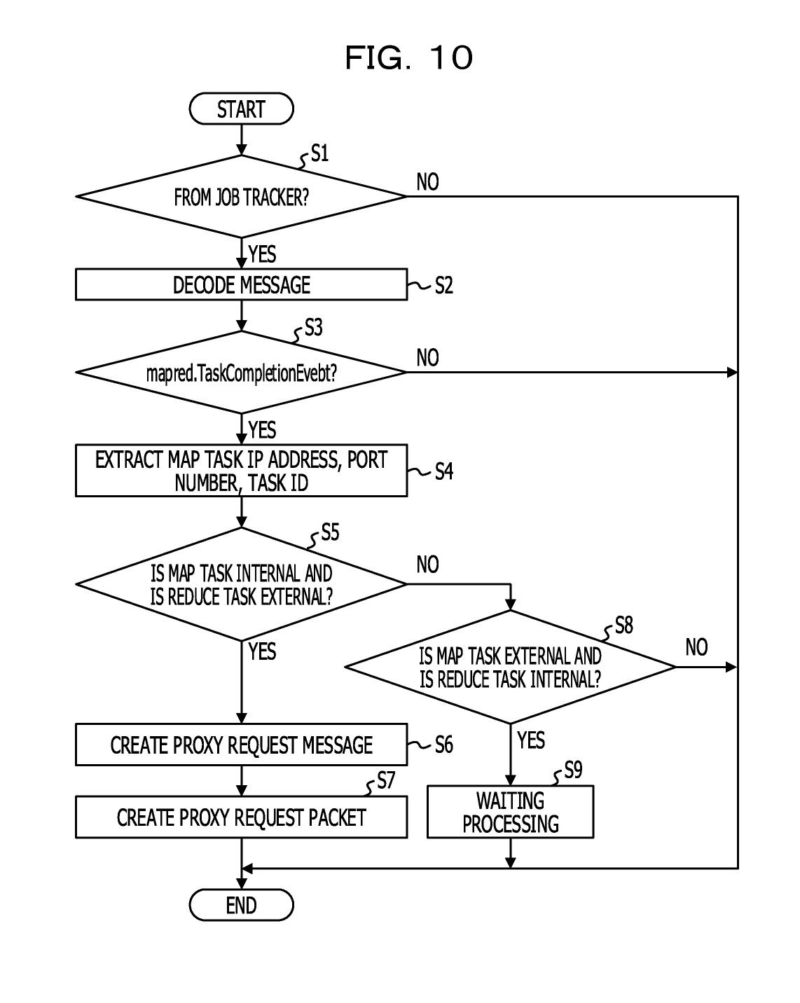

FIG. 10 is an example of a flow chart of processing related to a proxy request or a proxy response of the WAN acceleration device 1. The processing illustrated in FIG. 10 is conducted each time the WAN acceleration device 1 receives a packet.

In S1, the receiving side TCP processing unit 14 determines whether the transmission source of the reception packet is the Job Tracker 3. A reception packet in which the transmission source IP address and the transmission source port number of the reception packet respectively matches the IP address and the port number of the Job Tracker 3 is detected in the determination. If the transmission source of the reception packet is the Job Tracker 3 (S1: Yes), a copy of the reception packet is created and the reception packet (copy) is outputted to the decode processing unit 111. Then the processing advances to S2. If the transmission source of the reception packet is not the Job Tracker 3 (S1: No), the processing illustrated in FIG. 10 is finished.

In S2, the decode processing unit 111 decodes the reception packet (copy) detected in S1. The processing then advances to S3.

In S3, the decode processing unit 111 determines whether the reception packet is a “org.apache.hadoop.mapred.TaskCompletionEvent” message. If the reception packet is the “org.apache.hadoop.mapred.TaskCompletionEvent” message (S3: Yes) the processing advances to S4. If the reception packet is not the “org.apache.hadoop.mapred.TaskCompletionEvent” message (S3: No), the decode processing unit 111 discards the reception packet (copy) and then the processing illustrated in FIG. 10 is finished.

In S4, the decode processing unit 111 extracts from the reception packet the Map task node IP address, the Map task node port number, the Map task ID, and the target IP address as the Reduce task node IP address. The Map task node IP address, the Reduce task node IP address, and the Reduce task node port number are registered in the intermediate data session management table 114. The following explanation assumes that the IP address and the port number of the Map task node are extracted, and the IP address of the Reduce task node 4 is extracted as the target IP address from the reception packet that includes the “org.apache.hadoop.mapred.TaskCompletionEvent” message. The processing then advances to S5.

In S5, the HTTP proxy processing unit 112 determines whether the Map task node 2 indicated by the reception packet exists in the internal network and whether the Reduce task node 4 exists in the external network. The determination is made according to the IP addresses of the Map task node 2 and the Reduce task node 4. If the Map task node 2 exists in the internal network and the Reduce task node 4 exists in the external network (S5: Yes), the WAN acceleration device 1 is indicated, for example, to be the WAN acceleration device 1A of the Map task node 2 side in FIG. 5, and the processing advances to S6. If the Map task node 2 does not exist in the internal network and the Reduce task node 4 does not exist in the external network (S5: No), the processing advances to S8.

The processing in S6 and S7 is processing executed by the WAN acceleration device 1A on the Map task node 2 side in FIG. 5. In S6, the HTTP proxy processing unit 112 creates a HTTP GET request as a proxy request message. A URI that is created from the task ID extracted from the “org.apache.hadoop.mapred.TaskCompletionEvent” message is included in the HTTP GET request. The processing then advances to S7.

In S7, the TCP/IP header creating unit 113 creates a TCP/IP header for the HTTP GET message created by the HTTP proxy processing unit 112, and creates a proxy request packet. The target IP address, the target port number, the transmission source IP address, and the transmission source port number of the proxy request packet respectively become the Map task node 2 IP address, the Map task node 2 TCP port number, the Reduce task node 4 IP address, and the Reduce task node 4 port number. The proxy request packet is transmitted via the transfer processing unit 15, the transmission side TCP processing unit 17, the transmission side IP processing unit 18, and the transmission processing unit 19 to the Map task node. As a result, the processing illustrated in FIG. 10 is finished. When the data packet of the intermediate data transmitted from the Map task node 2 is received, the WAN acceleration device 1A transfers the data packet to the external network. The data packet of the intermediate data is buffered in the WAN acceleration device 1B and is transmitted to the Reduce task node 4 by the WAN acceleration device 1B when the HTTP GET request from the Reduce task node 4 reaches the WAN acceleration device 1B.

In S8, the HTTP proxy processing unit 112 determines whether the Map task node 2 indicated by the reception packet exists in the external network and whether the Reduce task node 4 exists in the internal network. If the Map task node 2 exists in the external network and the Reduce task node 4 exists in the internal network (S8: Yes), the WAN acceleration device 1 is indicated, for example, to be the WAN acceleration device 1B of the Reduce task node 4 side in FIG. 5, and the processing advances to S9.

The processing in S9 is executed by the WAN acceleration device 1B on the Reduce task node 4 side in FIG. 5. In S9, the HTTP proxy processing unit 112 waits for the intermediate data data packet. As a result, the processing illustrated in FIG. 10 is finished. When the data packet of the intermediate data transferred by the WAN acceleration device 1A reaches the WAN acceleration device 1B, the WAN acceleration device 1B stores the data packet in the prefetch buffer 115. When the HTTP GET request is received from the Reduce task node 4, the WAN acceleration device 1B reads the applicable intermediate data data packet from the prefetch buffer 115 and transmits the data packet to the Reduce task node 4.

If, in S8, the Map task node 2 does not exist in the external network and the Reduce task node 4 does not exist in the internal network (S8: No), the processing illustrated in FIG. 10 is finished. The WAN acceleration device 1 is a proxy and does not handle communication concluded within an internal network. If the Map task node 2 and the Reduce task node 4 both exist in the internal network, the WAN acceleration device 1 may not conduct the proxy processing since the transmission and reception of the intermediate data is not conducted through a WAN. If the Map task node 2 and the Reduce task node 4 both exist in the external network, the “org.apache.hadoop.mapred.TaskCompletionEvent” message from the Job Tracker 3 does not reach the WAN acceleration device 1 in the first place.

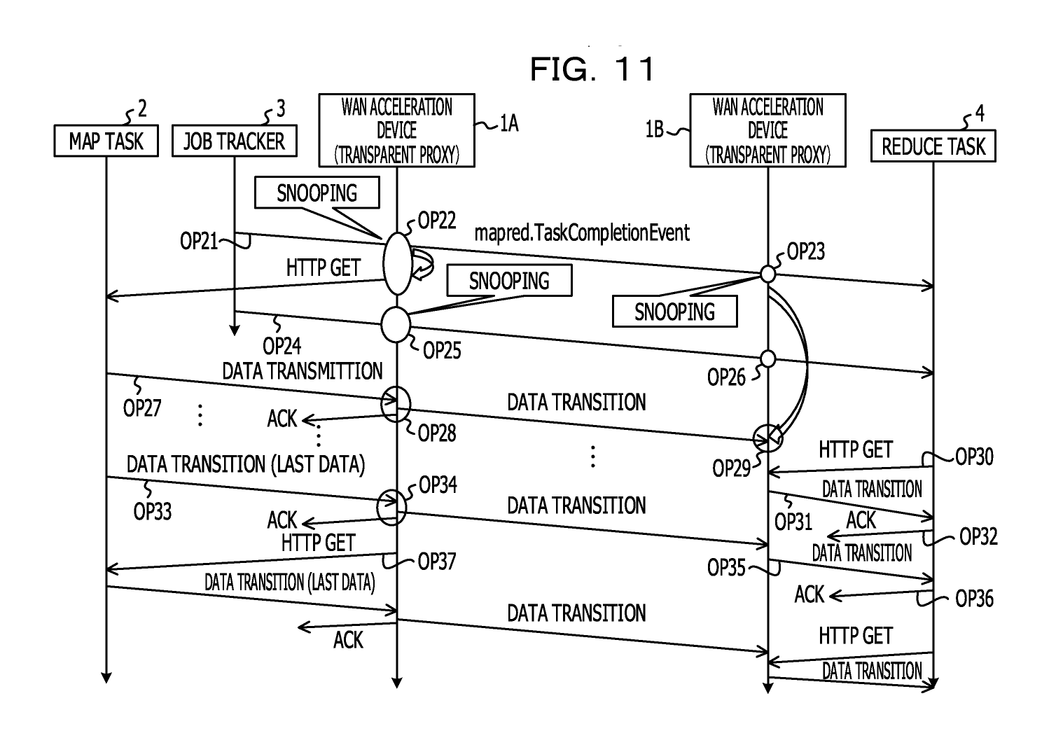

FIG. 11 illustrates an example of a sequence chart of processing related to a proxy request or a proxy response in the system illustrated in FIG. 5. FIG. 11 illustrates processing by the devices when the “org.apache.hadoop.mapred.TaskCompletionEvent” message which includes the contents that instruct obtaining the intermediate data from the Map task node 2 is transmitted by the Job Tracker 3 to the Reduce task node 4. In the example illustrated in FIG. 11, the WAN acceleration device 1A is assumed to conduct a proxy request of the next intermediate data after the reception of one instance of intermediate data is completed when a plurality of instances of intermediate data are requested to the Map task node 2. While the Map task ID in the following explanation differs from what is actually written, the Map task ID is expressed as task ID #1 and task ID #2 for convenience.

In OP21, the “org.apache.hadoop.mapred.TaskCompletionEvent” message is transmitted from the Job Tracker 3 to the Reduce task node 4. The Map task node 2 IP address and port number and the task ID #1 are included in the “org.apache.hadoop.mapred.TaskCompletionEvent” message.

In OP22, the WAN acceleration device 1A receives the “org.apache.hadoop.mapred.TaskCompletionEvent” message transmitted from the Job Tracker 3. The WAN acceleration device 1A transfers the “org.apache.hadoop.mapred.TaskCompletionEvent” message to the Reduce task node 4, conducts snooping of the contents, and transmits the HTTP GET request corresponding to the intermediate data of the task ID #1 to the Map task node 2 (FIG. 10, S1-S7).

In OP23, the WAN acceleration device 1B receives the “org.apache.hadoop.mapred.TaskCompletionEvent” message transferred from the WAN acceleration device 1A. The WAN acceleration device 1B transfers the “org.apache.hadoop.mapred.TaskCompletionEvent” message to the Reduce task node 4, conducts snooping of the contents, and waits for the data packet of the intermediate data of the task ID #1 (FIG. 10, S1-S5, S8-S9).

In OP24, the Job Tracker 3 re-transmits the “org.apache.hadoop.mapred.TaskCompletionEvent” message to the Reduce task node 4. The Map task node 2 IP address and port number and the task ID #2 are included in the “org.apache.hadoop.mapred.TaskCompletionEvent” message.

In OP25, the WAN acceleration device 1A receives the “org.apache.hadoop.mapred.TaskCompletionEvent” message transmitted by the Job Tracker 3. The WAN acceleration device 1A transfers the “org.apache.hadoop.mapred.TaskCompletionEvent” message to the Reduce task node 4 and conducts snooping of the contents. At this point in time, the HTTP GET request corresponding to the intermediate data of the task ID #2 is not transmitted to the Map task node 2 since the proxy request processing is being conducted with respect to the intermediate data of the task ID #1 included in the “org.apache.hadoop.mapred.TaskCompletionEvent” message received in OP22 (FIG. 10, S1-S7).

In OP26, the WAN acceleration device 1B receives the “org.apache.hadoop.mapred.TaskCompletionEvent” message transferred from the WAN acceleration device 1A. The WAN acceleration device 1B transfers the “org.apache.hadoop.mapred.TaskCompletionEvent” message to the Reduce task node 4. At this point in time, the WAN acceleration device 1B does not conduct the waiting processing since the WAN acceleration device 1B is already in a waiting state for the intermediate data.

In OP27, the Map task node 2 receives the HTTP GET request transmitted by the WAN acceleration device 1A and transmits the data packet of the intermediate data of the task ID #1. The intermediate data of the task ID #1 is the intermediate data of the task ID indicated in the “org.apache.hadoop.mapred.TaskCompletionEvent” message transmitted by the Job Tracker 3.

In OP28, the WAN acceleration device 1A receives the data packets of the intermediate data of the task ID #1 transmitted by the Map task node 2. The WAN acceleration device 1A transfers the data packet of the intermediate data of the task ID #1 to the Reduce task node 4 and also transmits an ACK to the Map task node 2 as a proxy response.

In OP29, the WAN acceleration device 1B receives the intermediate data data packet of the task ID #1 transferred by the WAN acceleration device 1A and stores the data packet in the prefetch buffer 115.

In OP30, the Reduce task node 4 transmits the HTTP GET request corresponding to the intermediate data of the task ID #1 to the Map task node 2.

In OP31, the WAN acceleration device 1B receives the HTTP GET request corresponding to the intermediate data of the task ID #1 from the Reduce task node 4. In OP 32, since the intermediate data data packet of the task ID #1 is stored in the prefetch buffer 115, the WAN acceleration device 1B reads the data packet and transmits the data packet to the Reduce task node 4 (proxy response).

In OP32, the Reduce task node 4 receives the data packet of the intermediate data of the task ID #1 and transmits an ACK. Although the ACK is addressed and transmitted to the Map task node 2, the ACK is terminated by the WAN acceleration device 1B.

In OP33, the Map task node 2 transmits the last data packet of the intermediate data of the task ID #1.

In OP34, the WAN acceleration device 1A receives the last data packet of the intermediate data of the task ID #1 transmitted by the Map task node 2. The WAN acceleration device 1A transfers the last data packet of the intermediate data of the task ID #1 to the Reduce task node 4 and also transmits an ACK to the Map task node 2 as a proxy response.

In OP35, the WAN acceleration device 1B receives the last intermediate data data packet of the task ID #1 transferred by the WAN acceleration device 1A and stores the data packet in the prefetch buffer 115, and transmits the last data packet to the Reduce task node 4 when the turn to transmit the last data packet is reached in the order. In OP36, the Reduce task node 4 receives the last data packet of the task ID #1 and transmits an ACK.

In OP37, the WAN acceleration device 1A transmits the HTTP GET request corresponding to the intermediate data of the task ID #2 to the Map task node 2 when the reception of the intermediate data of the task ID #1 is completed. The transmission and reception of the intermediate data of the task ID #2 is conducted hereinafter in the same way as OP27 to OP36.

### Effect of the Operation of the First Embodiment

In the first embodiment, the WAN acceleration device 1A conducts snooping on the “org.apache.hadoop.mapred.TaskCompletionEvent” message transmitted from the Job Tracker 3 and conducts a proxy request for the Map task node 2. The intermediate data transmitted from the Map task node 2 is buffered in the prefetch buffer 115 of the WAN acceleration device 1B due to the transfer by the WAN acceleration device 1A. Consequently, when the HTTP GET request is transmitted by the Reduce task node 4, the applicable intermediate data is buffered in the WAN acceleration device 1B and the intermediate data is transmitted from the WAN acceleration device 1B to the Reduce task node 4. Therefore, according to the first embodiment, the time from when the Reduce task node 4 transmits the HTTP GET request until the intermediate data is received may be shortened.

Further, when the intermediate data of the task ID #1 and #2 is obtained from the same Map task node 2, the WAN acceleration device 1A transmits the HTTP GET request to the Map task node 2 after the reception of the intermediate data of the task ID #1 is completed. This proxy request is conducted without waiting for the HTTP GET request corresponding to the intermediate data of the task ID #2 from the Reduce task node 4. Consequently, the time from when the Map task node 2 transmits the last data packet of the intermediate data of the task ID #1 until the transmission of the first data packet of the intermediate data of the task ID #2 may be shortened. Furthermore, the intermediate data of the task ID #2 may be prefetched and the time from the completion of the reception of the task ID #1 intermediate data by the Reduce task node 4 until the start of the reception of the task ID #2 intermediate data by the Reduce task node 4 may be shortened.

Further, according to the first embodiment, construction costs and operating costs may be lowered since adding modifications to the existing infrastructure or Hadoop nodes such as Job Trackers or Task Trackers are unnecessary. The execution time of all of Hadoop Jobs may be shortened due to the reduction of the time taken for the intermediate data communication.

### Second Embodiment

It is assumed in the first embodiment that, before transmitting and receiving the intermediate data, a TCP session between the Map task node 2 and the Reduce task node 4 is established and the port number of the Reduce task node 4 is known. This assumption is not observed in the second embodiment and a case in which a TCP session is established between the Map task node 2 and the Reduce task node 4 will be explained. The explanation of the second embodiment will also be predicated on the system illustrated in FIG. 5. Explanations in the second embodiment that duplicate explanations in the first embodiment will be omitted.

In the first embodiment, a TCP session between the Map task node 2 and the Reduce task node 4 is established before the reception of the “org.apache.hadoop.mapred.TaskCompletionEvent” message from the Job Tracker 3. As a result, the WAN acceleration device 1 is able to obtain the port number of the Reduce task node 4 beforehand and the proxy request to the Map task node 2 and the waiting processing for the intermediate data are able to be conducted upon the reception of the “org.apache.hadoop.mapred.TaskCompletionEvent” message.

Conversely, in the second embodiment, a TCP session between the Map task node 2 and the Reduce task node 4 is not established at the time of the reception of the “org.apache.hadoop.mapred.TaskCompletionEvent” message from the Job Tracker 3. First, the WAN acceleration device 1 executes processing to establish a TCP session between the Map task node 2 and the Reduce task node 4 once the “org.apache.hadoop.mapred.TaskCompletionEvent” message from the Job Tracker 3 is received. The WAN acceleration device 1 uses the IP addresses and the port numbers of the Map task node 2 and the Reduce task node 4 when establishing the TCP session between the Map task node 2 and the Reduce task node 4. The WAN acceleration device 1 is able to obtain the IP address and the port number of the Map task node 2 and the IP address of the Reduce task node 4 from the “org.apache.hadoop.mapred.TaskCompletionEvent” message. However, the WAN acceleration device 1 is not able to obtain the port number of the Reduce task node 4.

Thus in the second embodiment, the WAN acceleration device 1A on the Map task node 2 side creates the port number of the Reduce task node 4 upon receiving the “org.apache.hadoop.mapred.TaskCompletionEvent” message. The WAN acceleration device 1A uses this proxy port number to conduct the establishment of the TCP session and the proxy request.

The decode processing unit 111 of the WAN acceleration device 1A of the Map task node side extracts the IP address and the port number of the Map task node 2 Map task ID from the “org.apache.hadoop.mapred.TaskCompletionEvent” message from the Job Tracker 3. The decode processing unit 111 further extracts the target IP address of the reception packet included in the message as the IP address of the Reduce task node 4. The extracted Map task node 2 IP address and the Reduce task node 4 IP address are registered in the intermediate data session management table 114. The second embodiment is similar to the first embodiment up to this point.

In the first embodiment, the port number of the Reduce task node in the intermediate data session management table 114 is, for example, extracted from the applicable previously established TCP session information in the TCP session management information (not illustrated) held in the WAN acceleration device 1, and registered. In the second embodiment, when a TCP session that matches the extracted port number and the IP address of the Map task node 2 and the IP address of the Reduce task node 4 is not established, the HTTP proxy processing unit 112 creates a proxy port number and registers the proxy port number as the Reduce task node port number in the intermediate data session management table 114. The proxy port number may be, for example, selected randomly from unused port numbers.

Next, the HTTP proxy processing unit 112 of the WAN acceleration device 1A creates a TCP SYN packet to establish a TCP session with the Map task node 2 and transmits the TCP SYN packet to the Map task node 2. The target IP address, the target port number, and the transmission source IP address of the TCP SYN packet are respectively the IP address of the Map task node 2, the port number of the Map task node 2, and the IP address of the Reduce task node 4 extracted from the reception packet that includes the “org.apache.hadoop.mapred.TaskCompletionEvent” message. The transmission source port number is a proxy port number of the Reduce task node stored in the intermediate data session management table 114. The processing thereafter relating to the establishment of the TCP session with the Map task node 2 is conducted, for example, by the TCP proxy response processing unit 16. The TCP SYN packet of the second embodiment is an example of a “request packet.”

When the TCP session with the Map task node 2 is established, the HTTP proxy processing unit 112 notifies the WAN acceleration device 1B of the Reduce task node 4 side about the proxy port number of the Reduce task node 4. The notification of the created proxy port number of the Reduce task node 4 may involve, for example, the use of the protocol used between the WAN acceleration devices, but the notification method is not limited as such.

Next, the HTTP proxy processing unit 112 creates a HTTP GET request upon the establishment of the TCP session with the Map task node 2 and transmits the HTTP GET request to the Map task node 2. The created proxy port number of the Reduce task node 4 may also be used by the transmission source port number in the HTTP GET request.

The WAN acceleration device 1A uses the created proxy port number thereafter in the same way as in the first embodiment for conducting the transmission and reception of the intermediate data.

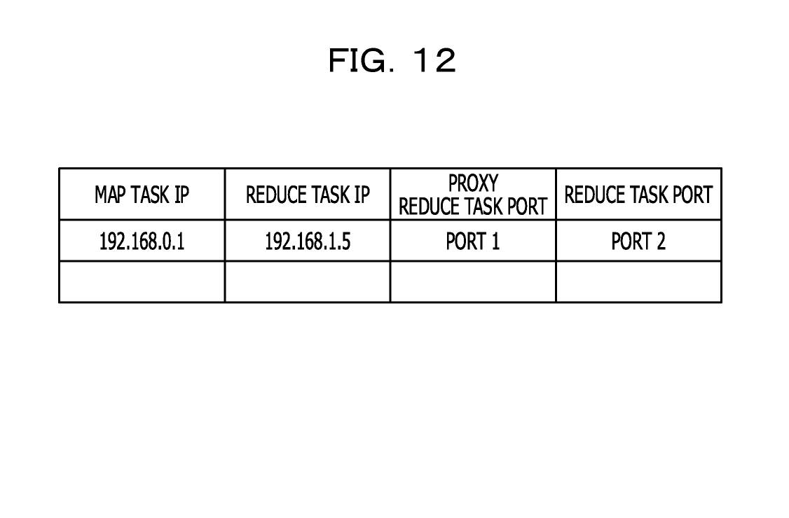

The WAN acceleration device 1B of the Reduce task node 4 side in the second embodiment holds a TCP session association table in place of the intermediate data session management table 114. The TCP session association table is a table for managing the TCP sessions between the WAN acceleration device 1B and the Reduce task node 4 and the TCP sessions between the WAN acceleration device 1B and the Map task node 2 in association with each other. The TCP session association table is created, for example, in a storage region in the main storage device 102. Details of the TCP session association table are described below with reference to FIG. 12.

The WAN acceleration device 1B on the Reduce task node 4 side stores the port number of the Reduce task node 4 created by the WAN acceleration device 1A and notified by the WAN acceleration device 1A, in the TCP session association table. The detection of the notification from the WAN acceleration device 1A and the storage in the TCP session association table are conducted with the use of the protocol used in the notification by the receiving side TCP processing unit 14 or the receiving side IP processing unit 13.

If the TCP session is not established, the Reduce task node 4 starts the establishment of a TCP session with the Map task node 2 when the “org.apache.hadoop.mapred.TaskCompletionEvent” message from the Job Tracker 3 is received. The WAN acceleration device 1B on the Reduce task node 4 side terminates the TCP SYN packet from the Reduce task node 4 and obtains the port number actually used by the Reduce task node 4 included in the TCP SYN packet. The port number is associated with the port number created by the WAN acceleration device 1A on the Map task node 2 side and stored in the TCP session association table.

Before the “org.apache.hadoop.mapred.TaskCompletionEvent” message reaches the Reduce task node 4, the WAN acceleration device 1B conducts snooping of the message and obtains the IP addresses of the Reduce task node 4 and the Map task node 2. Therefore, the receiving side TCP processing unit 14 in the WAN acceleration device 1B detects the TCP SYN packet in which the target IP address and the transmission source IP address are respectively the IP address of the Map task node 2 and the IP address of the Reduce task node 4. The receiving side TCP processing unit 14 also registers the port number of the Reduce task node 4 extracted from the TCP SYN packet in the TCP session association table.

The TCP proxy response processing unit 16 of the WAN acceleration device 1B of the Reduce task node 4 side establishes the TCP session with the Reduce task node 4 by proxy. When the TCP session with the Reduce task node 4 is established and the HTTP GET request is received from the Reduce task node 4, the TCP proxy response processing unit 16 reads the applicable data packet from the prefetch buffer 115 and transmits the data packet. At this time, the target port number in the intermediate data data packet is re-written by the transmission side TCP processing unit 17. The re-writing of the target port number is conducted by referring to the TCP session association table. Specifically, the target port number in the intermediate data data packet is re-written to the actually used port number of the Reduce task node 4 from the port number of the Reduce task node 4 created by the WAN acceleration device 1A on the Map task node 2 side.

FIG. 12 is an example of a TCP session association table held by the WAN acceleration device 1B on the Reduce task node side 4. The IP addresses of the Map task nodes, the IP addresses of the Reduce task nodes, the proxy port numbers of the Reduce task nodes, and the port numbers of the Reduce task nodes are stored in the TCP session association table. Since the port numbers of the Map task nodes are assumed to be unique in the second embodiment in the same way as in the first embodiment, the port numbers of the Map task nodes are not stored in the TCP session association table illustrated in FIG. 12. However, without being limited as such, the port numbers of the Map task nodes may be stored in the TCP session association table if the port numbers of the Map task nodes are not unique.

The IP address of the Map task node and the IP address of the Reduce task node are obtained by conducting snooping of the “org.apache.hadoop.mapred.TaskCompletionEvent” message. The proxy Reduce task node port number is a proxy port number created by the WAN acceleration device 1A on the Map task node 2 side. The proxy Reduce task node port number is obtained by a notification from the WAN acceleration device 1A on the Map task node 2 side. The Reduce task node port number is obtained from the TCP SYN packet at the time of the TCP session establishment.

### Operation Example

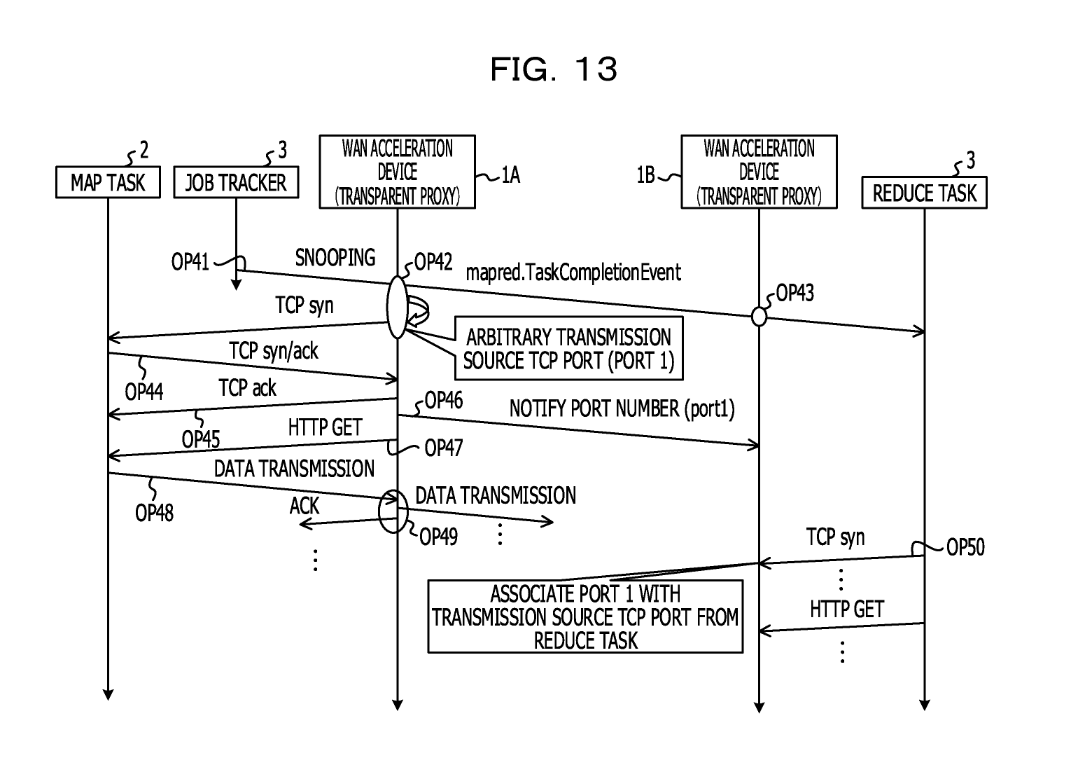

FIG. 13 illustrates an example of a sequence of a TCP session establishment before the transmission and reception of intermediate data according to a second embodiment. FIG. 13 illustrates a sequence of processing by the devices when the “org.apache.hadoop.mapred.TaskCompletionEvent” message which includes the contents that instruct obtaining the intermediate data from the Map task node 2 is transmitted by the Job Tracker 3 to the Reduce task node 4. It is assumed in the example illustrated in FIG. 13 that a TCP session between the Map task node 2 and the Reduce task node 4 is not established.

In OP41, an “org.apache.hadoop.mapred.TaskCompletionEvent” message is transmitted from the Job Tracker 3 to the Reduce task node 4. In OP42, the WAN acceleration device 1A receives the “org.apache.hadoop.mapred.TaskCompletionEvent” message transmitted by the Job Tracker 3. The WAN acceleration device 1A transfers the “org.apache.hadoop.mapred.TaskCompletionEvent” message to the Reduce task node 4 and conducts snooping of the contents. At this time, the WAN acceleration device 1A creates a proxy port number of the Reduce task node 4 and transmits a TCP SYN packet to the Map task node 2 with the proxy port number indicated as the transmission source port number.

In OP43, the WAN acceleration device 1B receives the “org.apache.hadoop.mapred.TaskCompletionEvent” message transferred by the WAN acceleration device 1A. The WAN acceleration device 1B transfers the “org.apache.hadoop.mapred.TaskCompletionEvent” message to the Reduce task node 4, conducts snooping of the contents, and registers the information in the TCP session association table.

In OP44 and OP45, processing to establish the TCP session between the Map task node 2 and the WAN acceleration device 1A is conducted.

In OP46, the WAN acceleration device 1A notifies the WAN acceleration device 1B about the created proxy port number of the Reduce task node. The WAN acceleration device 1B registers the proxy port number of the notified Reduce task node 4 in the TCP session association table. The WAN acceleration device 1B releases the proxy port number and waits for the intermediate data transferred by the WAN acceleration device 1A.

In OP47, the WAN acceleration device 1A uses the proxy port number of the Reduce task node 4 and transmits the HTTP GET request to the Map task node 2. In OP48, the Map task node that receives the HTTP GET request transmits the intermediate data. In OP49, the WAN acceleration device 1A receives the data packets of the intermediate data transmitted by the Map task node 2. The WAN acceleration device 1A transfers the data packet of the intermediate data to the Reduce task node 4 and also transmits an ACK to the Map task node 2 as a proxy response.

In OP50, the Reduce task node that received the “org.apache.hadoop.mapred.TaskCompletionEvent” message from the Job Tracker 3 transmits the TCP SYN packet to establish a TCP session with the Map task node 2. The port number actually used by the Reduce task node 4 is stored as the transmission source port number in the TCP SYN packet. When the TCP SYN packet is received, the WAN acceleration device 1B associates the proxy port number notified by the WAN acceleration device 1A and registers the transmission source port number (port number of the Reduce task node 4) of the TCP SYN packet in the TCP session association table. Processing to establish the TCP session between the Reduce task node 4 and the WAN acceleration device 1B is conducted hereafter. Hereinbelow, the transmission and reception of the intermediate data follows the first embodiment except for the feature of the transmission source port number being re-written by the WAN acceleration device 1B.

### Effects of the Operation of the Second Embodiment

A TCP session between the Map task node 2 and the Reduce task node 4 is not established in the second embodiment. As a result, when the WAN acceleration device 1A detects the “org.apache.hadoop.mapred.TaskCompletionEvent” message, a process to establish a TCP session with the Map task node 2 is executed. At this time, the WAN acceleration device 1A creates the proxy port number, since the port number of the Reduce task node 4 is unknown, and uses the proxy port number to establish a TCP session and to obtain the intermediate data. Consequently, when the TCP session is not established, the time taken from the “org.apache.hadoop.mapred.TaskCompletionEvent” message reaching the Reduce task node until the intermediate data reaches the Reduce task node may be shortened.

In the first and second embodiments, the WAN acceleration device 1 is described as operating as a transparent proxy. However, the embodiments are not limited as such and the proxy response processing and the proxy request processing described in the first and second embodiments may be applicable even if the WAN acceleration device 1 is a non-transparent proxy. If the WAN acceleration device 1 is a non-transparent proxy, the re-writing processing of the target and transmission source in the packets is applied during communication relaying between the internal network and the external network. While an example of a Hadoop system is described in the first and second embodiments, the description is not limited as such. The proxy request processing and the proxy response processing described in the first and second embodiments may be applicable to a system in which the data transmission and reception is started upon the reception of a packet from a third party node that is different from the node that receives the data. For example, systems for which the proxy request processing and the proxy response processing described in the first and second embodiments may be applicable include the Bulk Synchronous Parallel system, the Apache S4 system, the Storm system, and the like.

### Modified Example

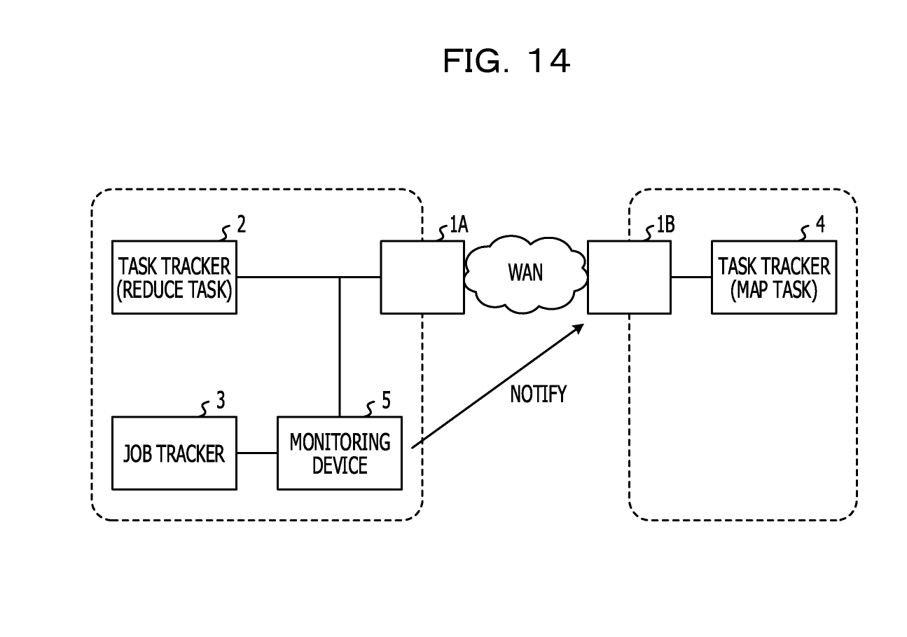

FIG. 14 illustrates an example of a system of a first modified example. In the first modified example, a monitoring device 5 is installed at the Job Tracker 3 WAN acceleration device 1A side.

In Hadoop, which Map task or which Reduce task is executed by a Task Tracker is dynamically determined by the Job Tracker 3. As indicated in the system illustrated in FIG. 5, when the Job Tracker 3 and the Reduce task node 4 exist in different networks, the WAN acceleration device 1A is able to detect the “org.apache.hadoop.mapred.TaskCompletionEvent” message. Consequently, the WAN acceleration device 1A is able to transmit the HTTP GET request and the TCP SYN packet to the Map task node 2 that exists in the internal network, and the time taken for the transmission and reception of the intermediate data may be shortened.

Conversely, in the system illustrated in FIG. 13, the Task Tracker 2 becomes a Reduce task node and the Task Tracker 4 becomes a Map task node. As a result, the transmission and reception of the “org.apache.hadoop.mapred.TaskCompletionEvent” message is concluded within the internal network and might not be detected by the WAN acceleration device 1A.

Accordingly, in the modified example, the monitoring device 5 monitors the packets transmitted from the Job Tracker 3 and notifies the WAN acceleration device 1B that exists in the same network as the Map task node 4 that exists in an external network about the “org.apache.hadoop.mapred.TaskCompletionEvent” message or desired information. Upon receiving the notification, the WAN acceleration device 1B transmits the HTTP GET request or the TCP SYN packet to the Map task node as described in the first and second embodiments, to conduct the proxy request.

The monitoring device 5 may be, for example, a computer such as a server, and the hardware configuration is substantially the same as that illustrated in FIG. 7. The monitoring device 5 has functional blocks related to the detection of the “org.apache.hadoop.mapred.TaskCompletionEvent” message in the WAN acceleration device 1 according to the first and second embodiments. As a result, the functional blocks of the monitoring device 5 may be the ones illustrated in FIG. 8 except for the TCP proxy response processing unit 16, the HTTP proxy processing unit 112, the intermediate data session management table 114, the prefetch buffer 115, or the TCP/IP header creating unit 113 that conduct the processing related to proxy request or proxy response.

When the monitoring device 5 detects the “org.apache.hadoop.mapred.TaskCompletionEvent” message transmitted from the Job Tracker 3, the message may be encapsulated and may be sent to the WAN acceleration device 1B of the Map task node 4 side. The monitoring device 5 may extract desired information from the “org.apache.hadoop.mapred.TaskCompletionEvent” message and may notify the WAN acceleration device 1B of the Map task node 4 side about the desired information. The desired information is, for example, included in the “org.apache.hadoop.mapred.TaskCompletionEvent” message and is the IP address and the port number of the Map task node 4, the Map task ID, and the IP address of the Reduce task node 2. Which Task Tracker (Map task node) exists in the same network as either of the WAN acceleration devices 1 is assumed to be set beforehand in the monitoring device 5.

Due to the installation of the monitoring device 5, the processing of the proxy request or the proxy response by the WAN acceleration device 1 as explained in the first and second embodiments may be applicable even when the Job Tracker and the Reduce task node exist in the same network.

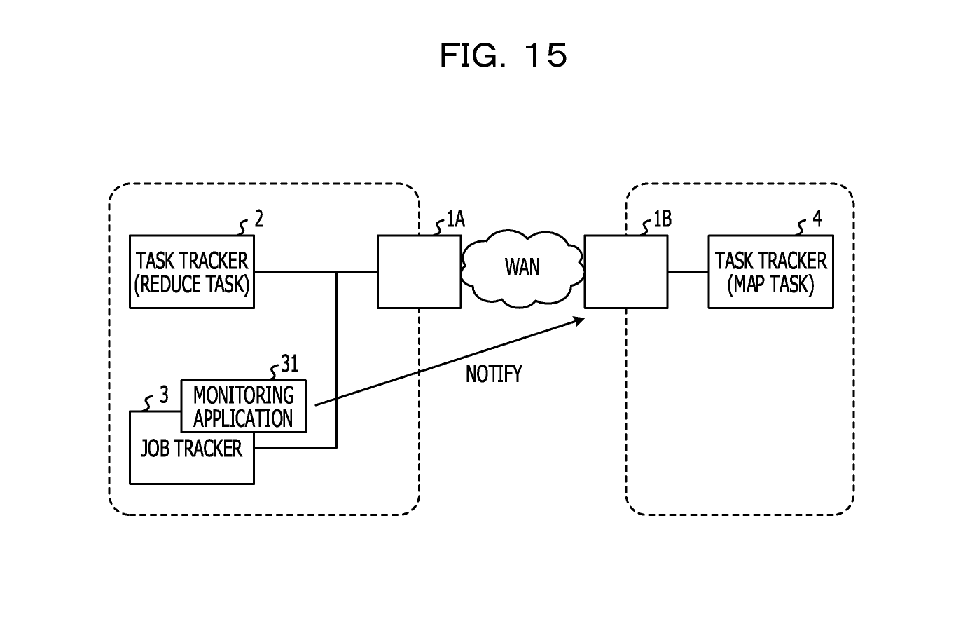

FIG. 15 illustrates an example of a system of a second modified example. In the second modified example, the processing of the monitoring device 5 from the first modified example is incorporated into the Job Tracker 3 as a monitoring application 31 and conducted by the Job Tracker 3. The Job Tracker is one unit in the Hadoop system and thus installation costs and initial investments may be lowered.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processor apparatus comprising:
a memory which stores a program; and
a processor, based on the program, configured to:
detect a packet that is transmitted from a management device to a second node that is included in a second network, and that triggers a request packet transmitted from the second node to a first node that is included in a first network, by monitoring communication from the management device that manages the first node and the second node that obtains data from the first node through a third network; and
execute a proxy request by transmitting the request packet to the first node when the packet is detected and a connection is made with the first network.

2. The information processor apparatus according to claim 1,
wherein the packet includes information that identifies the data, and
wherein the processor is configured to:
extract from the packet the information that identifies the data; and
create the request packet using the information that identifies the data.

3. The information processor apparatus according to claim 1,
wherein the processor is configured to:
create, as a proxy, a port number used by the second node when the packet is detected in a state in which a session between the first node and the second node is not established and when the first node exists in the same network as the information processor apparatus; and
use the port number and transmit the request packet for requesting a session establishment with the first node.

4. The information processor apparatus according to claim 3,
wherein the processor is configured to:
notify another information processor apparatus that exists in the second network and that is located at a border with the first network, of the port number.

5. The information processor apparatus according to claim 3,
wherein the processor is configured to:
transmit a second request packet for requesting the data to the first node when a session is established with the first node.

6. The information processor apparatus according to claim 1,
wherein the processor is configured to:
transmit the data to the second node as a proxy of the first node for the data received from the first node when the second node exists in an internal network.

7. An information processor apparatus comprising:
detecting a packet that is transmitted from a management device to a second node that is included in a second network, and that triggers a request packet transmitted from the second node to a first node that is included in a first network, by monitoring communication from the management device that manages the first node and the second node that obtains data from the first node through a third network; and
executing a proxy request by transmitting the request packet to the first node when the packet is detected and a connection is made with the first network.

8. A computer-readable recording medium having stored therein a program for causing a client apparatus to execute a digital signature process comprising:
detecting a packet that is transmitted from a management device to a second node that is included in a second network, and that triggers a request packet transmitted from the second node to a first node that is included in a first network, by monitoring communication from the management device that manages the first node and the second node that obtains data from the first node through a third network; and
executing a proxy request by transmitting the request packet to the first node when the packet is detected and a connection is made with the first network.
